(19) United States
(12) Patent Application Publication
(10) Pub. No.: US 2022/0284287 A1
(43) Pub. Date: Sep. 8, 2022

(54) ROBUST ARTIFICIAL NEURAL NETWORK HAVING IMPROVED TRAINABILITY

(71) Applicant: Robert Bosch GmbH, Stuttgart (DE)

(72) Inventors: Christian Haase-Schuetz, Fellbach (DE); Frank Schmidt, Leonberg (DE); Torsten Sachse, Koeln (DE)

(21) Appl. No.: 17/637,890

(22) PCT Filed: Jul. 28, 2020
(86) PCT No.: PCT/EP2020/071311

§ 371 Date: Feb. 24, 2022

(30) Foreign Application Priority Data
Sep. 11, 2019 (DE) 10 2019 213 898.5

(51) Int. Cl. G06N 3/08; G06N 3/04

(52) U.S. Cl. CPC G06N 3/08; G06N 3/0481

(57) ABSTRACT

An artificial neural network (ANN), including processing layers which are each configured to process input quantities in accordance with trainable parameters of the ANN to form output quantities. At least one normalizer is inserted into at least one processing layer and/or between at least two processing layers. The normalizer includes a transformation element configured to transform input quantities directed into the normalizer into one or more input vectors, using a predefined transformation. The normalizer also includes a normalizing element configured to normalize the input vector(s) using a normalization function, to form one or more output vectors. The normalization function has at least two different regimes and changes between the regimes as a function of a norm of the input vector at a point and/or in a range, whose position is a function of a predefined parameter. The normalizer also includes an inverse transformation element.

### FIELD

The present invention relates to artificial neural networks, in particular, for use in determining a classification, a regression, and/or semantic segmentation of physical measurement data.

### BACKGROUND INFORMATION

To drive a vehicle in road traffic in an at least partially automated manner, it is necessary to monitor the surroundings of the vehicle and identify the objects present in these surroundings and, in some instances, to determine their position relative to the reference vehicle. On this basis, it may subsequently be decided if the presence and/or a detected motion of these objects makes it necessary to change the behavior of the reference vehicle.

Since, for example, optical imaging of the surroundings of the vehicle, using a camera, is subject to a number of influence factors, no two images of one and the same scenery are completely identical. Thus, for the identification of objects, artificial neural networks (ANN's) having, ideally, high power are used for generalization. These ANN's are trained in such a manner, that they map input learning data effectively to output learning data in accordance with a cost function. It is then expected that the ANN's also identify objects accurately in situations, which were not the subject of the training.

In deep neural networks having a multitude of layers, it is problematic that there is no control over the orders of magnitude, over which the numerical values of the data processed by the network range. For example, numbers in the range of 0 to 1 may be present in the first layer of the network, while numerical values on the order of 1000 may be reached in deeper layers. Small changes in the input quantities may then produce large changes in the output quantities. A result of this may be that the network “does not learn,” that is, that the success rate of the identification does not significantly exceed that of a random rate.
(S. Ioffe, C. Szegedy, “Batch Normalization: Accelerating Deep Network Training by Reducing Internal Covariate Shift”, arXiv: 1502.03167v3 [cs.LG] (2015)) describes normalizing the numerical values of the data generated in the ANN per processed mini-batch of training data to a uniform order of magnitude.
(D.-A. Clevert, T. Unterthirner, S. Hochreiter, “Fast and Accurate Deep Network Learning by Exponential Linear Units (ELUs)”, arXiv:1511.07289 [cs.LG] (2016)) describes activations of neurons, using a new kind of activation function, which lessens the above-mentioned problem.

### SUMMARY

An artificial neural network in provided in accordance with the present invention. This network includes a plurality of processing layers connected in series. The processing layers are each configured to process input quantities in accordance with trainable parameters of the ANN to form output quantities. In this context, in particular, the output quantities of a layer may each be directed into at least the next layer as input quantities.

In accordance with an example embodiment of the present invention, a new normalizer is inserted into at least one processing layer and/or between at least two processing layers.

This normalizer includes a transformation element. This transformation element is configured to transform input quantities directed into the normalizer into one or more input vectors, using a predefined transformation. In this instance, each of the input quantities enters into exactly one input vector. Thus, a single input vector or a collection of input vectors is produced, which has, in total, exactly the same amount of information, that is, e.g., exactly the same amount of numerical values, as were supplied to the normalizer in the input quantities.

The normalizer further includes a normalizing element. This normalizing element is configured to normalize the input vector(s) with the aid of a normalizing function, to form one or more output vectors. In the spirit of the present invention, normalization of a vector is understood to be, in particular, an arithmetic operation, which leaves the number of components of the vector and its direction in the multidimensional space unchanged, but is able to change its norm defined in this multidimensional space. The norm may correspond to, for example, a length of the vector in the multidimensional space. In particular, the normalization function may be such, that it is able to map vectors, which have markedly different norms, to vectors, which have similar or like norms.

The normalization function has at least two different regimes and changes between the regimes as a function of a norm of the input vector at a point and/or in a range, whose position is a function of a predefined parameter ρ. This means that input vectors, whose norm is to the left of the point and/or range (that is, is somewhat smaller), are treated differently by the normalization function from input vectors, whose norm is to the right of the point and/or range (that is, is somewhat larger). In particular, the one regime may include, for example, during the calculation of the output vector, changing the norm of the input vector absolutely and/or relatively less markedly than provided under the other regime. One of the regimes may also include, for example, not changing the input vector at all, but taking it on unchanged as an output vector.

The normalizer further includes an inverse transformation element. The inverse transformation element is configured to transform the output vectors into output quantities, using the inverse of the predefined transformation. These output quantities have the same dimensionality as the input quantities supplied to the normalizer. In this manner, the normalizer may be inserted at an arbitrary position between two processing steps in the ANN. Thus, in the further processing by the ANN, the output quantities of the normalizer may take the place of the quantities, which were acquired previously in the ANN and supplied to the normalizer as input quantities.

In accordance with the present invention, it has been recognized that the numerical stability of the normalization function may be improved, in particular, by changing the regime as a function of the norm of the input vector and specified parameter ρ. In particular, the tendency of normalization functions to increase the unavoidable rounding errors in the machine processing of input quantities, as well as the noise always present in physical measurement data, is counteracted.

Within the ANN's, the rounding errors and the noise generate small non-zero numerical values at points, at which there should actually be zeros in the ideal case. In comparison to this, numerical values, which represent the useful signal contained in the physical measurement data and/or the inferences drawn from them, are markedly greater. If, between two processing steps in the ANN, the numerical values, which represent intermediate results already present, are now combined to form vectors and these vectors are normalized, then the result of this may be that, on one hand, an interval originally present between the useful signal and its processing products, and on the other hand, noise and/or rounding errors, are leveled partially or even completely.

Using the change between the regimes, it may now be determined, for example, that all of the input vectors, whose norm does not reach a certain minimum degree, are not changed or only slightly changed in their norm. If, for example, input vectors having larger norms are simultaneously mapped to output vectors having equal or similar norms, a sufficiently large normlike interval with regard to the output vectors, which originates from noise and/or rounding errors, still remains.

This, in turn, lowers the standards regarding the statistics of the input quantities, which are supplied to the normalizer. It is not necessary to always fall back upon input quantities, which originate from different samples of input quantities supplied to the ANN. Instead, the important information contained in the above-mentioned intermediate result of the ANN is preserved, if only numerical values of this intermediate result, which relate to a single sample of input quantities supplied to the ANN, are supplied to the normalizer.

Thus, the advantages attainable until now with the aid of batch normalization may be attained to the same extent or to a greater extent, without it being necessary for the normalization to apply to mini-batches of training data processed during the training of the ANN. Consequently, the effectiveness of the normalization is also, in particular, no longer a function of the size of the mini-batches selected during the training.

This, in turn, allows the size of the mini-batches to be selected completely freely, for example, from the standpoint of the data throughput during the training of the ANN. For a maximum throughput, it is particularly advantageous to select the size of the mini-batches in such a manner, that a mini-batch just fits in the available working memory (for instance, video RAM of utilized graphics processors (GPU's)) and may be processed concurrently. This is not always the same size of mini-batches, which is also optimal for batch normalization in terms of a maximum performance (e.g., classification accuracy) of the network. On the contrary, a smaller or larger size of the mini-batches may be advantageous for the batch normalization; when in doubt, optimal batch normalization (and therefore, optimal accuracy with regard to the task) then typically having priority over optimum data throughput during training. In addition, the batch normalization functions very poorly for small batch sizes, since the statistics of the mini-batch then approximate the statistics of all of the training data only in a highly inadequate manner.

Furthermore, in contrast to the batch size of the batch normalization, the parameter ρ used by the normalizing element is a continuous and indiscrete parameter. Consequently, this parameter p is available for optimization in a markedly more effective manner. For example, it may be trained together with the trainable parameters of the ANN. However, optimization of the batch size of the batch normalization may make it necessary to carry out the entire training of the ANN anew for each tested batch-size candidate, which increases the training expenditure accordingly.

The ANN may be trained, all in all, in an efficient manner and, at the same, also becomes robust in opposition to manipulation attempts using so-called adversarial examples. These attempts are directed at deliberately causing, for example, a false classification by the ANN, using a small, inconspicuous change in the data, which are supplied to the ANN. The influence of such changes within the ANN is repressed by the normalization. Thus, in order to obtain the desired false classification, a suitably large manipulation would have to be undertaken at the input of the ANN, which then has a high probability of standing out.

In one particularly advantageous refinement of the present invention, at least one normalization function is configured to leave input vectors, whose norm is less than parameter ρ, unchanged, and to normalize input vectors, whose norm is greater than parameter ρ, to a uniform norm, while maintaining the direction. One example of such a normalization function, which is clarified for vectors in an arbitrary multidimensional space, includes:

$${\hat{π}}_{ρ} ( \vec{x} ) = \frac{\vec{x}}{max ( 1 , \frac{‖ \vec{x} ‖}{ρ} )} .$$

If the norm ∥\vec{x}∥ of vector \vec{x} is less than ρ, then vector \vec{x} remains unchanged. This is the first regime of the normalization function \hat{π}_{ρ}(\vec{x}). However, if ∥\vec{x}∥ is at least equal to ρ, then \hat{π}_{ρ}(\vec{x}) projects vector \vec{x} onto a spherical surface having radius ρ. This means that the normalized vector then points in the same direction as before, but ends on the spherical surface. This is the second regime of normalization function \hat{π}_{ρ}(\vec{x}). When ∥\vec{x}∥=ρ, then a change is made between the two regimes.

In a further, particularly advantageous refinement of the present invention, the change of at least one normalization function between the different regimes is controlled by a softplus function, whose argument has a zero crossing when the norm of the input vector is equal to parameter ρ. An example of such a function is

$${\hat{π}}_{ρ} ( \vec{x} ) = \frac{\vec{x}}{1 + softplus ( \frac{‖ \vec{x} ‖ - ρ}{ρ} )}$$

In this, the softplus function is given by

softplus(y)=ln(1+exp(y)).

The advantage of this function is that it is differentiable in ρ. Now, vectors \vec{x} having ∥\vec{x}∥ less than ρ no longer remain unchanged, but in comparison with vectors \vec{x} having a larger norm ∥\vec{x}∥, they are changed markedly less. When ∥\vec{x}∥ tends to 0, then norm ∥\vec{x}∥ of the vector \vec{x} in the multidimensional space is reduced by approximately 25% independently of the value of ρ. There is no norm ∥\vec{x}∥, for which π_{ρ}(\vec{x}) results in an increase of the norm. Thus, not only is the influence of, for example, rounding errors and noise prevented from being increased, but also this influence is reduced even further, in that norms ∥\vec{x}∥ that are overly low are lowered more and are simply not raised to a uniform level.

In a further, particularly advantageous refinement of the present invention, at least one predefined transformation of the input quantities of the normalizer to the input vectors includes transforming a tensor of input quantities into one or more input vectors. The tensor includes a number f of feature maps, which assign n different locations one feature information item each. The tensor may be written, for example, as X∈R^{n×f}. The normalizer then needs only at least feature information items, which are derived from a single sample of the input quantities inputted into the ANN. The use of mini-batches of samples continues to be possible, but is left to one's discretion.

In one further, particularly advantageous refinement of the present invention, for each of the f feature maps, at least one predefined transformation includes combining the feature information items for all locations contained in this feature map to form an input vector assigned to this feature map. Thus, for i=1, . . . , f, the complete ith feature map is fetched out, and the values included in it are written consecutively into the input vector \vec{x}ᵢ:

\vec{x}ᵢ=X(1, . . . , n; i).

In this manner, tensor X is converted successively into input vectors \vec{x}ᵢ, where i=1, . . . , f. Consequently, norms ∥\vec{x}ᵢ∥ are calculated over entire feature maps, and the greater the expression of certain features in the input values, the greater the norms.

In one further, particularly advantageous refinement of the present invention, for each of the n locations, at least one predefined transformation includes combining the feature information items assigned to this location by all of the feature maps to form an input vector assigned to this location. Therefore, for j=1, . . . , n, for the jth location, the value of the feature information item noted exactly for this location is fetched out, in each instance, in all of the feature maps, and the values obtained in this manner are written consecutively into input vector \vec{x}ⱼ:

\vec{x}ⱼ=X(j;1, . . . ,f).

In this manner, tensor X is converted successively into input vectors \vec{x}ⱼ. Thus, norms ∥\vec{x}ⱼ∥ are calculated over repertoires of the features, which are assigned, in each instance, to individual locations; and the more feature-rich the input quantities are with regard to the specific location, the larger the norms are.

In one further, particularly advantageous refinement of the present invention, at least one predefined transformation includes combining all feature information items from tensor X in a single input vector. Then, the more feature-rich the utilized sample of the input quantities supplied to the ANN is on the whole, the larger is the norm ∥\vec{x}∥ of this input vector \vec{x}.

In each of the above-mentioned refinements of the present invention, tensor X, that is, vectors \vec{x}, \vec{x}ᵢ, and \vec{x}ⱼ, may be subjected to further preprocessing prior to use of the normalization function. In particular,
in each instance, an arithmetic mean (overall sample mean=mean over all information items regarding the respective sample of the input quantities of the ANN) may be subtracted from all of the feature information items; and/or
from the respective feature information items contained in each of the f feature maps, in each instance, an arithmetic mean of the feature information item calculated over this feature map may be subtracted, and/or
from the feature information items assigned to each of the n locations by all of the feature maps, in each instance, an arithmetic mean of the feature information items belonging to this location may be subtracted.

As explained above, the normalizer may be “looped in” at any desired position in the ANN, since its output quantities have the same dimensionality as its input quantities and may therefore take the place of these input quantities during the further processing in the ANN.

In one particularly advantageous refinement of the present invention, at least one normalizer receives a weighted summation of input quantities of a processing layer as input quantities. The output quantities of this normalizer are directed into a nonlinear activation function for calculating output quantities of the processing layer. If a normalizer is connected to this position in many or even all of the processing layers, then the behavior of the nonlinear activation functions within the ANN may be standardized to a large extent, since these activation functions always operate on values in mainly the same order of magnitude.

In a further, particularly advantageous refinement of the present invention, at least one normalizer receives output quantities of a first processing layer as input quantities, which were calculated, using a nonlinear activation function. The output quantities of this normalizer are directed as input quantities into a further processing layer, which sums these input quantities in a weighted manner in accordance with the trainable parameters. If many or even all transitions between adjacent processing layers in the ANN lead through a normalizer, then the orders of magnitude of the input quantities, which each enter into the weighted summation, may be substantially standardized within the ANN. This ensures that the training converges more effectively.

As explained above, in the described ANN in accordance with the present invention, in particular, the accuracy, with which it learns a classification, a regression, and/or a semantic segmentation of real and/or simulated physical measurement data, may be improved markedly. In particular, the accuracy may be measured, for example, with the aid of validating input quantities, which were not already used during the training and are known as ground truth for the validating output quantities (that is, for instance, a setpoint classification to be obtained or a setpoint regression value to be obtained). In addition, the susceptibility to adversarial examples is also reduced. Thus, in a particularly advantageous refinement, the ANN takes the form of a classifier and/or regressor.

An ANN taking the form of a classifier may be used, for example, to identify objects and/or states of objects sought within the scope of the specific application, in the input quantities of the ANN. Thus, for instance, an autonomous agent, such as a robot or a vehicle traveling in an at least partially automated manner, must identify objects in its surroundings, in order to be able to act appropriately in the situation characterized by a particular constellation of objects. For example, in the scope of medical imaging, as well, an ANN taking the form of a classifier may identify features (such as damage), from which a medical diagnosis may be derived. In an analogous manner, such an ANN may also be used within the scope of optical inspection, in order to check if manufactured products or other work results (such as welded seams) are or are not satisfactory.

A semantic segmentation of physical measurement data may be generated, for example, by classifying parts of the measurement data as to the type of object, to which they belong.

In particular, the physical measurement data may be, for example, image data, which were recorded, using spatially resolved sensing of electromagnetic waves in, for example, the visible range, or also, e.g., by a thermal camera in the infrared range. The spatially resolved components of the image data may be, for example, pixels, stixels or voxels as a function of the specific space, in which these images reside, that is, as a function of the dimensionality of the image data. The physical measurement data may also be obtained, for example, by measuring reflections of a sensing radiation within the scope of radar, lidar or ultrasonic measurements.

In the above-mentioned applications, an ANN taking the form of a regressor may also be used as an alternative to this, or in combination with this. In this function, the ANN may supply information about a continuous quantity sought within the scope of the specific application. Examples of such quantities include dimensions and/or speeds of objects, as well as continuous measures for evaluating the product quality (for instance, the roughness or the number of defects in a welded seam), or features, which may be used for a medical diagnosis (for instance, a percentage of a tissue, which should be regarded as damaged).

Thus, in general, the ANN particularly advantageously takes the form of a classifier and/or regressor for identifying and/or quantitatively evaluating, in the input quantities of the ANN, objects and/or states sought in the scope of the specific application.

The ANN particularly advantageously takes the form of a classifier for identifying
traffic signs; and/or
pedestrians; and/or
other vehicles; and/or
other objects, which characterize a traffic situation,

from physical measurement data, which are obtained by monitoring a traffic situation in the surroundings of a reference vehicle, using at least one sensor. This is one of the most important tasks for traveling in an at least partially automated manner. In the field of robotics, as well, or in the case of general, autonomous agents, sensing of the surroundings is highly important.

In principle, the effect described above and attainable by the normalizer in an ANN is not limited to the normalizer's constituting a unit encapsulated in some form. It is only important that intermediate products generated during the processing are subjected to the normalization at a suitable location in the ANN, and that the result of the normalization is used in place of the intermediate products during the further processing in the ANN.

Thus, the present invention relates generally to a method for operating an ANN having a plurality of processing layers connected in series, which are each configured to process input quantities in accordance with trainable parameters of the ANN, to form output quantities.

In the scope of this method, in accordance with an example embodiment of the present invention, in at least one processing layer and/or between at least two processing layers, a set of quantities ascertained as input quantities during the process is extracted from the ANN for normalization. The input quantities for the normalization are transformed, using a predefined transformation, into one or more input vectors; each of these input quantities going into exactly one input vector.

The input vector(s) are normalized with the aid of a normalization function to form one or more output vectors; this normalization function having at least two different regimes and changing between the regimes as a function of a norm of the input vector at a point and/or in a range, whose position is a function of a predefined parameter ρ.

The output vectors are transformed by the inverse of the predefined transformation into output quantities of the normalization, which have the same dimensionality as the input quantities of the normalization. Subsequently, the processing in the ANN is continued; the output quantities of the normalization taking the place of the previously extracted input quantities of the normalization.

All of the description given above with regard to the functionality of the normalizer is expressly valid for this method, as well.

According to what has been described up to this point, the present invention also relates to a system, which is configured to control other technical systems on the basis of an evaluation of physical measurement data, using the ANN. The system includes at least one sensor for recording physical measurement data, the ANN described above, as well as a control unit. The control unit is configured to generate a control signal for a vehicle or another autonomous agent (such as a robot), a classification system, a system for the quality control of mass-produced products, and/or a system for medical imaging, from output quantities of the ANN. All of the above-mentioned systems profit from the fact that the ANN learns, in particular, a desired classification, regression and/or semantic segmentation more effectively than ANN's, which rely on a batch normalization or on an ELU activation function.

The sensor may include, for example, one or more image sensors for light of any visible or invisible wavelengths, and/or at least one radar, lidar or ultrasonic sensor.

According to what is described above, the present invention also relates to a method for training and operating the ANN described above. In the scope of this method, input learning quantities are supplied to the ANN. The input learning quantities are processed by the ANN to form output quantities. An evaluation of the output quantities, which specifies how effectively the output quantities are in accord with output learning quantities belonging to the input learning quantities, is ascertained in accordance with a cost function.

The trainable parameters of the ANN are optimized together with at least one parameter ρ described above, which characterizes the transition between the two regimes of a normalization function. During the further processing of input learning quantities, the objective of this optimization is to obtain output quantities, whose evaluation by the cost function is expected to be more effective. This does not mean that each optimizing step must necessarily be an improvement in this regard; on the contrary, the optimization may also learn from “incorrect paths,” which initially result in deterioration.

In the large number, typically several thousand to several million, of trainable parameters, one or more additional parameters ρ are not of any consequence in the training expenditure for the ANN as a whole. This is in contrast to the optimization of discrete parameters, such as the batch size for batch normalization. As explained above, an optimization of such discrete parameters makes it necessary to run through the complete training of the ANN once more for each candidate value of the discrete parameter. Therefore, by also training the additional parameter ρ as a continuous parameter within the scope of the training method, the overall expenditure is markedly reduced in comparison with the batch normalization.

In addition, the joint training of the parameters of the ANN, as well as of one or more additional parameters ρ, may also make use of synergy effects between the two training instances. Thus, for example, during the learning, changes in the trainable parameters, which directly control the processing of the input quantities by processing layers to form output quantities, may advantageously interact with changes in the additional parameters ρ, which have an effect on the normalization function. Using “combined forces” in such a manner, particularly “difficult cases” of classification and/or regression may be managed, for example.

The fully trained ANN may be supplied, as input quantities, physical measurement data recorded by at least one sensor. These input quantities may then be processed by the trained ANN to form output quantities. A control signal for a vehicle or another autonomous agent (such as a robot), a classification system, a system for the quality control of mass-produced products, and/or a system for medical imaging, may then be generated from the output quantities. The vehicle, the classification system, the system for the quality control of mass-produced products, and/or the system for medical imaging, may ultimately be controlled by this control signal.

According to what is described above, the present invention also relates to a further method, which includes the complete chain of action from providing the ANN to controlling a technical system.

This additional method starts with the provision of the ANN. The trainable parameters of the ANN, as well as, optionally, at least one parameter ρ, which optimizes the transition between the two regimes of a normalization function, are then trained in such a manner, that input learning quantities are processed by the ANN to form output quantities, which are in accord with output learning quantities belonging to the input learning quantities, under the condition of a cost function.

The fully trained ANN is supplied, as input quantities, physical measurement data recorded by at least one sensor. These input quantities are processed by the trained ANN to form output quantities. A control signal for a vehicle or another autonomous agent (such as a robot), a classification system, a system for the quality control of mass-produced products, and/or a system for medical imaging, is generated from the output quantities. The vehicle, the classification system, the system for the quality control of mass-produced products, and/or the system for medical imaging, is controlled by this control signal.

In this context, the improved learning capabilities of the ANN described above have the effect that by controlling the corresponding technical system, the probability is high that the action, which is appropriate in the situation represented by the physical measurement data, will be initiated.

The methods may be implemented, in particular, completely or partially, by computer. Thus, the present invention also relates to a computer program including machine-readable instructions, which, when they are executed on one or more computers, cause the computer(s) to carry out one of the described methods. Along these lines, control units for vehicles and embedded systems for technical devices, which are likewise able to execute machine-readable instructions, are also to be regarded as computers.

The present invention also relates to a machine-readable storage medium and/or to a download product including the computer program. A download product is a digital product, which is transmittable over a data network, that is, is downloadable by a user of the data network, and may, for example, be offered for sale in an online shop for immediate downloading.

In addition, a computer may be supplied with the computer program, with the machine-readable storage medium, and/or with the download product.

Further measures improving the present invention are represented below in more detail, in light of figures, together with the description of the preferred exemplary embodiments of the present invention.

### BRIEF DESCRIPTION OF THE DRAWINGS

FIG. 1 shows an exemplary embodiment of ANN 1, in accordance with the present invention.

FIG. 2 shows an exemplary embodiment of normalizer 3, in accordance with the present invention.

FIG. 3 shows an example of a tensor 31′ including input quantities 31 of normalizer 3, in accordance with the present invention.

FIG. 4 shows an exemplary embodiment of the system 10 including ANN 1, in accordance with the present invention.

FIG. 5 shows an exemplary embodiment of method 100 for training and operating ANN 1, in accordance with the present invention.

FIG. 6 shows an exemplary embodiment of the method 200 including a complete chain of action from providing ANN 1 to controlling a technical system, in accordance with the present invention.

### DETAILED DESCRIPTION OF EXAMPLE EMBODIMENTS

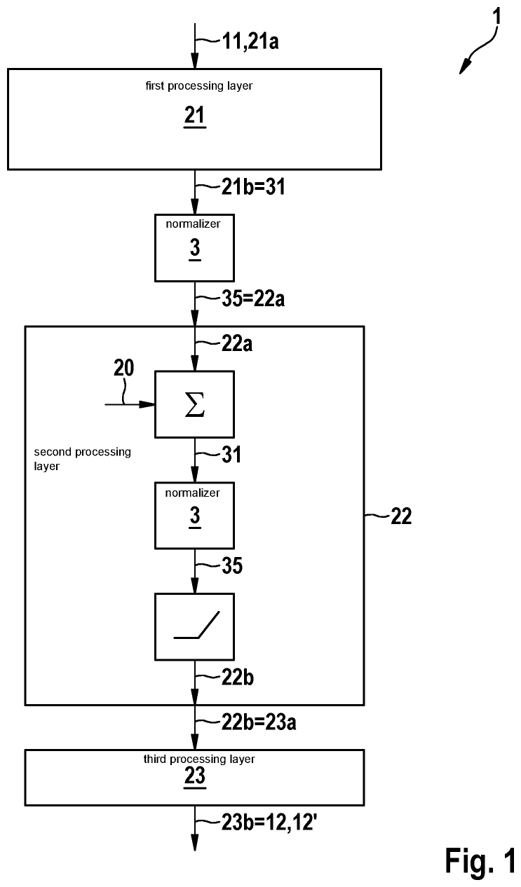

The ANN 1 shown by way of example in FIG. 1 includes three processing layers 21-23. Each processing layer 21-23 receives input quantities 21a-23a and processes them to form output quantities 21b-23b. At the same time, input quantities 21a of first processing layer 21 are also input quantities 11 of the ANN 1 as a whole. Output quantities 23b of third processing layer 23 are, at the same time, the output quantities 12, 12′ of ANN 1 as a whole. Actual ANN's 1, in particular, for use in classification or in other computer vision applications, are considerably deeper and include several tens of processing layers 21-23.

Two exemplary options of how a normalizer 3 may be introduced into ANN 1, are drawn into FIG. 1.

One option is to supply output quantities 21b of first processing layer 21 to normalizer 3 as input quantities 31, and then to supply output quantities 35 of the normalizer to second processing layer 22 as input quantities 22a.

The processing proceeding in second processing layer 22, including a second option for integrating normalizer(s) 3, is schematically represented inside of box 22. Input quantities 22a are initially summed in accordance with trainable parameters 20 of ANN 1 to form one or more weighted sums, which is indicated by the summation sign. The result is supplied to normalizer 3 as input quantities 31. Output quantities 35 of normalizer 3 are converted by a nonlinear activation function (in FIG. 1, indicated as an ReLU function) to output quantities 22b of second processing layer 22.

A plurality of different normalizers 3 may be used within one and the same ANN 1. Each normalizer 3 may then have, in particular, its own parameters ρ for the transition between the regimes of its normalization function 33. In addition, each normalizer 3 may also be coupled to its own specific preprocessing element.

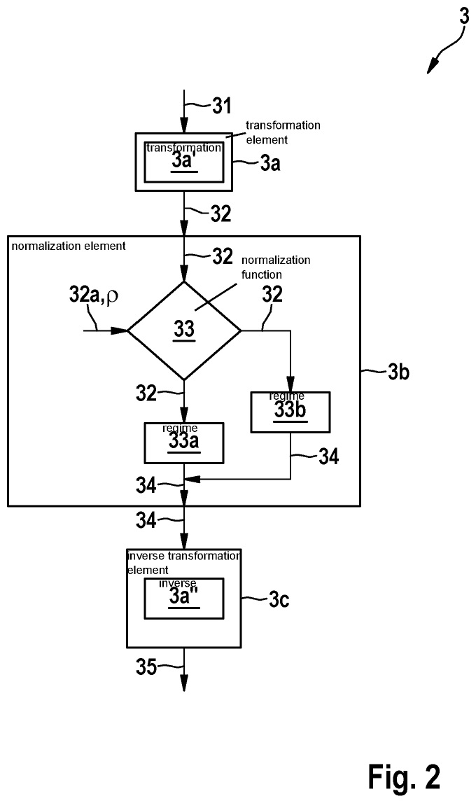

FIG. 2 shows an exemplary embodiment of normalizer 3. Normalizer 3 transforms its input quantities 31 into one or more input vectors 32, using a transformation element 3a, which implements a predefined transformation 3a′. These input vectors 32 are supplied to normalization element 3b, and there, they are normalized to form output vectors 34. Output vectors 34 are transformed in inverse transformation element 3c in accordance with inverse 32a″ of predefined transformation 3a′, into output quantities 35 of normalizer 3, which have the same dimensionality as input quantities 31 of normalizer 3.

How the normalization of input vectors 32 proceeds to form output vectors 34, is shown in detail inside of box 3b. The normalization function 33 utilized includes two regimes 33a and 33b, in each of which it shows a qualitatively different behavior and acts, in particular, with a different intensity upon input vectors 32. In interaction with at least one predefined parameter ρ, norm 32a of respective input vector 32 decides, which of regimes 33a and 33b is used. For purposes of illustration, this is represented as a binary decision in FIG. 2. In reality, however, it is particularly advantageous for regimes 33a and 33b to merge in a fluid manner, in particular, in a manner that is differentiable in parameter ρ.

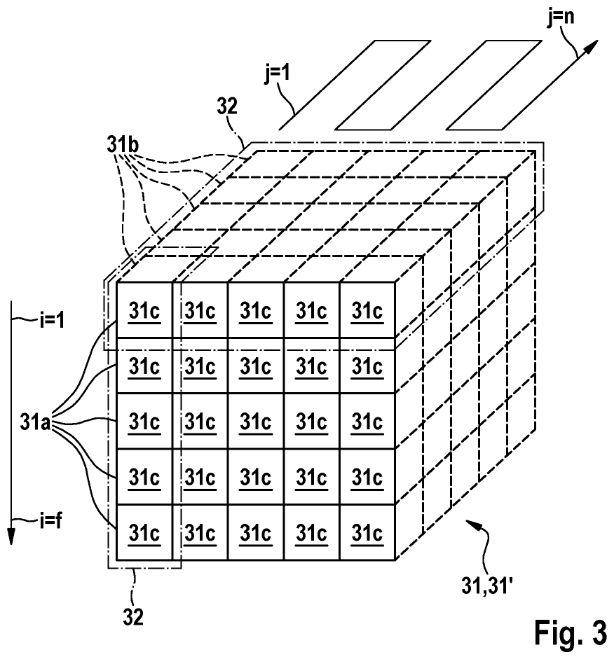

FIG. 3 shows an example of a tensor 31′ of input quantities 31 of normalizer 3. In this example, tensor 31′ is organized as a stack of f feature maps 31a. Thus, an index i over feature maps 31a runs from 1 to f. Each feature map 31a assigns each of n locations 31b feature information item 31c. Thus, an index j over locations 31b runs from 1 to n.

By way of example, two options of how input vectors 32 may be generated are drawn into FIG. 3. According to a first option, in each instance, all of the feature information items 31c of a feature map 31a (in this case, the feature map 31a for i=1) are combined in an input vector 32. According to a second option, in each instance, all of the feature information items 31c, which belong to the same location 31b (in this case, the location 31b for j=1), are combined in an input vector 32. A third option, which is not drawn into FIG. 3 for the sake of clarity, is to write all of the feature information items 31c from the entire tensor 31′ into a single input vector 32.

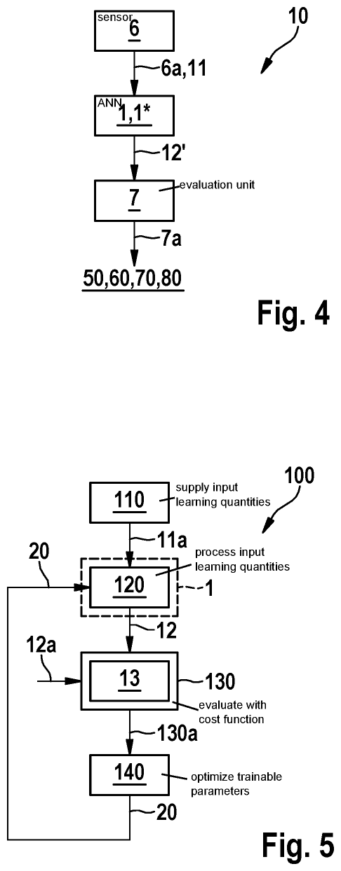

FIG. 4 shows an exemplary embodiment of system 10, by which further technical systems 50-80 may be controlled. At least one sensor 6 is provided for recording physical measurement data 6a. Measurement data 6a are supplied as input quantities 11 to ANN 1, which may be present, in particular, in its fully trained state 1*. The output quantities 12′ supplied by ANN 1, 1* are processed in evaluation unit 7 to form a control signal 7a. This control signal 7a is intended for the control of a vehicle or another autonomous agent (such as a robot) 50, a classification system 60, a system 70 for the quality control of mass-produced products, and/or a system 80 for medical imaging.

FIG. 5 is a flow chart of an exemplary embodiment of the method 100 for training and operating ANN 1. In step 110, input learning quantities 11a are supplied to ANN 1. In step 120, input learning quantities 11a are processed by ANN 1 to form output quantities 12; the behavior of ANN 1 being characterized by trainable parameters 20. In step 130, the extent, to which output quantities 12 are in accord with output learning quantities 12a belonging to input learning quantities 11a, is evaluated in accordance with a cost function 13. In step 140, trainable parameters 20 are optimized with the objective that in the case of further processing of input learning quantities 11a by ANN 1, output quantities 12 are obtained, for which more effective evaluations 130a are ascertained in step 130.

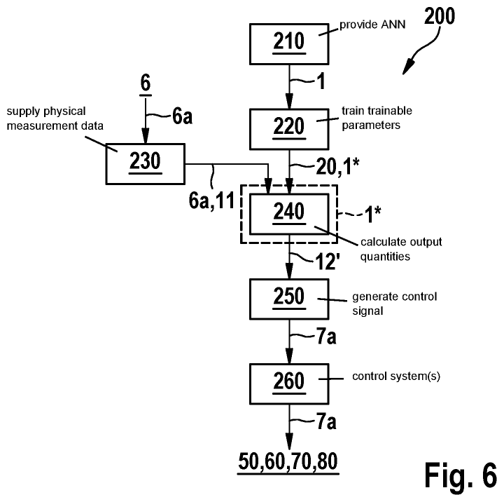

FIG. 6 is a flow chart of an exemplary embodiment of method 200, including the complete chain of action from providing an ANN 1 to controlling above-mentioned systems 50, 60, 70, 80.

In step 210, ANN 1 is provided. In step 220, trainable parameters 20 of ANN 1 are trained, so that trained state 1* of ANN 1 is generated. In step 230, physical measurement data 6a, which are ascertained by at least one sensor 6, are supplied to trained ANN 1* as input quantities 11. In step 240, output quantities 12′ are calculated by trained ANN 1*. In step 250, a control signal 7a is generated from output quantities 12′. In step 260, one or more of systems 50, 60, 70, 80 are controlled, using control signal 7a.

1-22. (canceled)

23. An artificial neural network (ANN), comprising:
a plurality of processing layers connected in series, which are each configured to process input quantities in accordance with trainable parameters of the ANN to form output quantities; and
at least one normalizer inserted into at least one of the processing layers and/or between at least two of the processing layers, each normalizer of the at least one normalizer including:
a transformation element, which is configured to transform input quantities directed into the normalizer into one or more input vectors, using a predefined transformation, each of the input quantities going into exactly one of the one or more input vectors,
a normalizing element, which is configured to normalize each input vector of the one or more input vectors using a normalization function, to form one or more output vectors, the normalization function having at least two different regimes and is configured to change between the regimes as a function of a norm of the input vector at a point and/or in a range, whose position is a function of a predefined parameter ρ, and
an inverse transformation element, which is configured to transform the one or more output vectors, using an inverse of the predefined transformation, into output quantities, which have the same dimensionality as the input quantities supplied to the normalizer.

24. The ANN as recited in claim 23, wherein the normalization function of at least one of the at least one normalizer is configured to leave input vectors, whose norm is less than the parameter ρ, unchanged and to normalize input vectors, whose norm is greater than the parameter ρ, to a uniform norm, while retaining a direction.

25. The ANN as recited in claim 23, wherein the change of the normalization function of at least one of the at least one normalizer between the different regimes is controlled by a softplus function, whose argument has a zero crossing when the norm of the input vector is equal to the parameter ρ.

26. The ANN as recited in claim 23, wherein from a tensor of the input quantities, in which a number f of feature maps are combined that each assign a feature information item to n different locations, the predefined transformation of at least one of the at least one normalizer includes combining all feature information items into one or more input vectors.

27. The ANN as recited in claim 26, wherein for each feature map of the f feature maps, the predefined transformation of at least one of the at least one normalizer includes combining the feature information items for all locations contained in the feature map to form an input vector assigned to the feature map.

28. The ANN as recited in claim 26, wherein for each location of the n locations, the predefined transformation of at least one of the at least one normalizer includes combining the feature information items assigned to the location by all of the feature maps, to form an input vector assigned to the location.

29. The ANN as recited in claim 26, wherein the predefined transformation of at least one of the at least one normalizer includes combining all feature information items from the tensor to form a single input vector.

30. The ANN as recited in claim 26, wherein the predefined transformation of at least one of the at least one normalizer includes subtracting, in each instance, an arithmetic mean calculated over all of the feature information items, from all of the feature information items.

31. The ANN as recited in claim 26, wherein the predefined transformation of at least one of the at least one normalizer includes subtracting, in each instance, from the feature information items contained in each feature map of the f feature maps, an arithmetic mean of the feature information items calculated over the feature map.

32. The ANN as recited in claim 26, wherein the predefined transformation of at least one of the at least one normalizer includes subtracting, from the feature information items assigned by all of the feature maps to each location of the n locations, in each instance, an arithmetic mean, which is of the feature information items belonging to the location and is calculated over all feature maps.

33. The ANN as recited in claim 23, wherein a normalizer of the at least one normalizer receives a weighted summation of input quantities of a processing layer as input quantities, and output quantities of the normalizer are directed into a nonlinear activation function to calculate output quantities of the processing layer.

34. The ANN as recited in claim 23, wherein a normalizer of the at least one normalizer receives, as input quantities, output quantities of a first processing layer, which are calculated, using a nonlinear activation function, and the output quantities of the normalizer are directed as input quantities into a further processing layer, which sums the input quantities in a weighted manner in accordance with the trainable parameters.

35. The ANN as recited in claim 23, wherein the ANN takes the form of a classifier and/or regressor for determining a classification and/or a regression and/or a semantic segmentation, from actual and/or simulated physical measurement data.

36. The ANN as recited in claim 35, wherein the ANN takes the form of a classifier and/or regressor for identifying and/or quantitatively evaluating objects and/or states in the input quantities of the ANN, the objects and/or states being sought within the scope of a specific application.

37. The ANN as recited in claim 35, wherein the ANN takes the form of a classifier for identifying, from physical measurement data which are obtained by monitoring a traffic situation in surroundings of a reference vehicle using at least one sensor:
traffic signs, and/or
pedestrians, and/or
other vehicles, and/or
other objects which characterize the traffic situation.

38. A method for operating an artificial neural network (ANN), including a plurality of processing layers connected in series, which are each configured to process input quantities in accordance with trainable parameters of the ANN to form output quantities, the method comprising the following steps:
in at least one processing layer of the processing layers and/or between at least two of the processing layers, extracting, a set of quantities ascertained as input quantities during processing, from the ANN for normalization;
transforming the input quantities for the normalization by a predefined transformation into one or more input vectors, each of the input quantities going into exactly one of the one or more input vectors;
normalizing each input vector of the one or more input vectors using a normalization function to form one or more output vectors, the normalization function having at least two different regimes and is configured to change between the regimes as a function of a norm of the input vector at a point and/or in a range, whose position is a function of a predefined parameter ρ;
transforming the output vectors by an inverse of the predefined transformation into output quantities of the normalization, which have the same dimensionality as the input quantities of the normalization;
continuing processing in the ANN, the output quantities of the normalization taking the place of the input quantities of the normalization extracted previously.

39. A system, comprising:
at least one sensor configured to record physical measurement data;
an ANN into which the physical measurement data are directed as input quantities, the ANN including:
a plurality of processing layers connected in series, which are each configured to process the input quantities in accordance with trainable parameters of the ANN to form output quantities, and
at least one normalizer inserted into at least one of the processing layers and/or between at least two of the processing layers, each normalizer of the at least one normalizer including:
a transformation element, which is configured to transform input quantities directed into the normalizer into one or more input vectors, using a predefined transformation, each of the input quantities going into exactly one of the one or more input vectors,
a normalizing element, which is configured to normalize each input vector of the one or more input vectors using a normalization function, to form one or more output vectors, the normalization function having at least two different regimes and is configured to change between the regimes as a function of a norm of the input vector at a point and/or in a range, whose position is a function of a predefined parameter ρ, and
an inverse transformation element, which is configured to transform the one or more output vectors, using an inverse of the predefined transformation, into output quantities, which have the same dimensionality as the input quantities supplied to the normalizer; and
a control unit configured to generate, from the output quantities of the ANN, a control signal for: (i) a vehicle or another autonomous agent, and/or (ii) a classification system, and/or (iii) a system for quality control of mass-produced products, and/or (iv) a system for medical imaging.

40. A method for training and operating an ANN, the ANN including:
a plurality of processing layers connected in series, which are each configured to process the input quantities in accordance with trainable parameters of the ANN to form output quantities, and
at least one normalizer inserted into at least one of the processing layers and/or between at least two of the processing layers, each normalizer of the at least one normalizer including:
a transformation element, which is configured to transform input quantities directed into the normalizer into one or more input vectors, using a predefined transformation, each of the input quantities going into exactly one of the one or more input vectors,
a normalizing element, which is configured to normalize each input vector of the one or more input vectors using a normalization function, to form one or more output vectors, the normalization function having at least two different regimes and is configured to change between the regimes as a function of a norm of the input vector at a point and/or in a range, whose position is a function of a predefined parameter ρ, and
an inverse transformation element, which is configured to transform the one or more output vectors, using an inverse of the predefined transformation, into output quantities, which have the same dimensionality as the input quantities supplied to the normalizer,
the method comprising the following steps:
supplying input learning quantities to the ANN;
processing the input learning quantities by the ANN to form the output quantities;
ascertaining an evaluation of the output quantities, which specifies how effectively the output quantities are in accord with output learning quantities belonging to the input learning quantities, in accordance with a cost function;
optimizing the trainable parameters of the ANN together with at least one parameter ρ, which optimizes a transition between the regimes of the normalization function, with an objective of obtaining, during further processing of the input learning quantities, output quantities whose evaluation by the cost function is expected to be more effective.

41. The method as recited in claim 40, further comprising the following steps:
supplying to the trained ANN physical measurement data recorded by at least one sensor as input quantities, and processing the physical measurement data by the trained ANN to form the output quantities;
generating from the output quantities a control signal for: (i) a vehicle or another autonomous agent, and/or (ii) a classification system, and/or (iii) a system for quality control of mass-produced products, and/or (iv) a system for medical imaging;
controlling, using the control signal, the vehicle and/or the classification system and/or the system for the quality control of mass-produced products and/or the system for medical imaging.

42. A non-transitory machine-readable storage medium on which is stored a computer program for operating an artificial neural network (ANN), including a plurality of processing layers connected in series, which are each configured to process input quantities in accordance with trainable parameters of the ANN to form output quantities, the computer program, when executed by a computer, causing the computer to perform the following steps:
in at least one processing layer of the processing layers and/or between at least two of the processing layers, extracting, a set of quantities ascertained as input quantities during processing, from the ANN for normalization;
transforming the input quantities for the normalization by a predefined transformation into one or more input vectors, each of the input quantities going into exactly one of the one or more input vectors;
normalizing each input vector of the one or more input vectors using a normalization function to form one or more output vectors, the normalization function having at least two different regimes and is configured to change between the regimes as a function of a norm of the input vector at a point and/or in a range, whose position is a function of a predefined parameter ρ;
transforming the output vectors by an inverse of the predefined transformation into output quantities of the normalization, which have the same dimensionality as the input quantities of the normalization;
continuing processing in the ANN, the output quantities of the normalization taking the place of the input quantities of the normalization extracted previously.

43. A computer configured to operate an artificial neural network (ANN), including a plurality of processing layers connected in series, which are each configured to process input quantities in accordance with trainable parameters of the ANN to form output quantities, the computer configured to:
in at least one processing layer of the processing layers and/or between at least two of the processing layers, extract, a set of quantities ascertained as input quantities during processing, from the ANN for normalization;
transform the input quantities for the normalization by a predefined transformation into one or more input vectors, each of the input quantities going into exactly one of the one or more input vectors;
normalize each input vector of the one or more input vectors using a normalization function to form one or more output vectors, the normalization function having at least two different regimes and is configured to change between the regimes as a function of a norm of the input vector at a point and/or in a range, whose position is a function of a predefined parameter ρ;
transform the output vectors by an inverse of the predefined transformation into output quantities of the normalization, which have the same dimensionality as the input quantities of the normalization;
continue to process in the ANN, the output quantities of the normalization taking the place of the input quantities of the normalization extracted previously.
